(19) United States
(12) Patent Application Publication
(10) Pub. No.: US 2025/0123421 A1
(43) Pub. Date: Apr. 17, 2025

(54) QUANTITATIVE RISK ASSESSMENT FOR RAIN-INDUCED LANDSLIDES

(71) Applicant: The Hong Kong University of Science and Technology, Kowloon (HK)

(72) Inventors: Limin ZHANG, Oscar By The Sea (HK); Jian HE, Sai Kung (HK)

(21) Appl. No.: 18/891,640

(22) Filed: Sep. 20, 2024

Related U.S. Application Data
(60) Provisional application No. 63/590,465, filed on Oct. 15, 2023.

(51) Int. Cl. G01W 1/10; G06N 7/01

(52) U.S. Cl. CPC G01W 1/10; G06N 7/01

(57) ABSTRACT

Described is technology that facilitates assessment of landslide-related uncertainties to forecast one or more consequences and/or damages corresponding to a predicted landslide. For instance, operations can be performed, comprising identifying a set of region parameters defining a land region that is susceptible to landslides, identifying rainfall data representative of rainfall for the land region, based on the rainfall data and the set of region parameters, assessing probability of landslide occurrence, and generating report data representative of the predicted landslide comprising probability data indicative of the probability of landslide occurrence.

### CROSS REFERENCE TO RELATED APPLICATION

This is a nonprovisional claiming priority under 35 U.S.C. § 119 of U.S. Provisional Patent Application No. 63/590,465, filed on Oct. 15, 2023, entitled “Prompt Quantittive Risk Assessment for Rain-Induced Landslides,” the entirety of which prior application is hereby incorporated by reference herein.

### BACKGROUND

An extreme rainstorm can cause thousands of landslides and kill hundreds or more people. In the current rapidly changing climate, fatal rainstorms can become more frequent and/or intense.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present one or more concepts of the disclosure in a streamlined form as a prelude to the more detailed description that is presented later.

Described herein are one or more frameworks directed to presenting real-time information on distributions of rainfall, landslides, economic loss, and/or loss of life, based quantifying a propagation of uncertainties in landslide source, volume, runout distance, and/or impact at a regional scale.

An example system can comprise at least one memory that stores executable instructions that, when executed by the at least one processor, facilitate performance of operations, comprising identifying a set of region parameters defining a land region that is susceptible to landslides, identifying rainfall data representative of rainfall for the land region, based on the rainfall data and the set of region parameters, assessing probability of landslide occurrence, and generating report data representative of the predicted landslide comprising probability data indicative of the probability of landslide occurrence.

An example method, such as a computer-implemented method, can comprise assigning, by a system comprising at least one processor, weights to landslide uncertainties corresponding to landslide parameters based on region parameters for a land region, based on rainfall data for the land region, quantifying propagation of the landslide uncertainties over a specified range of time that is about 24 hours or less in advance from a current time, and generating report data defining the landslide uncertainties over the specified range of time.

An example non-transitory machine-readable medium can comprise executable instructions that, when executed by at least one processor facilitate performance of operations. The operations can comprise, based on rainfall data that is live rainfall data applicable to a land region or predicted rainfall applicable to the land region predicted within a first specified range of time, generating a landslide probability distribution corresponding to the land region and a landslide volume distribution corresponding to the land region, based on a group of region parameters for the land region, comprising a topography parameter corresponding to a topography for the land region, an economic distribution parameter corresponding to the land region, and a population distribution parameter corresponding to a population distribution corresponding to the land region, generating damage data corresponding to the land region based on the landslide probability distribution and the landslide volume distribution, and generating report data comprising the damage data over a group of time points of a second specified range of time.

An example benefit of one or more of the above-indicated method, system and/or non-transitory computer-readable medium can be an ability to provide a proactive process for landslide damage prediction as opposed to existing reactive processes. In this way, societal resilience can be enhanced in the face of climate change adaptation.

Another example benefit of one or more of the above-indicated method, system and/or non-transitory computer-readable medium can be an ability to provide a concise one-page risk assessment report for which the underlying data can be generated using a common computing device, such as a laptop. In this way, the one or more embodiments described herein are user friendly and have a low barrier to use, and thus the use can be more widespread.

Yet another example benefit of one or more of the above-indicated method, system and/or non-transitory computer-readable medium can be an ability to provide accurate prediction of both economic damage (e.g., infrastructure damage) and loss of life (e.g., fatalities) based on accurate prediction of landslides using a framework for quantifying the propagation of uncertainties in landslide source, volume, runout and/or impact, without being limited thereto, at a regional scale. Likewise, the one or more embodiments described herein can facilitate notification regarding various risks, resource allocation, and/or targeted emergency response, all based on the one or more predictions provided.

### BRIEF DESCRIPTION OF THE DRAWINGS

The technology described herein is illustrated by way of example and not limited to the accompanying figures in which like reference numerals indicate similar elements.

FIG. 1 illustrates a block diagram of an example, non-limiting system that can provide quantifying the propagation of uncertainties in landslide source, volume, runout and impact at a regional scale, in accordance with one or more example embodiments described herein.

FIG. 2 illustrates a block diagram of example parameters that can be employed by the non-limiting system of FIG. 1, in accordance with one or more example embodiments described herein.

FIG. 3 illustrates a schematic diagram of an example risk assessment process that can be performed by the non-limiting system of FIG. 1, in accordance with one or more example embodiments described herein.

FIG. 4 illustrates a schematic diagram of a region for which the example risk assessment process of FIG. 3 can be performed, in accordance with one or more example embodiments described herein.

FIG. 5 illustrates example portions of the example risk assessment process of FIG. 3, in accordance with one or more example embodiments and/or implementations described herein.

FIG. 6 illustrates example portions of the example risk assessment process of FIG. 3, in accordance with one or more example embodiments and/or implementations described herein.

FIG. 7 illustrates an example portion of an example risk assessment report that can be generated by the non-limiting system of FIG. 1, in accordance with one or more example embodiments and/or implementations described herein.

FIG. 8 illustrates another example portion of the example risk assessment report that can be generated by the non-limiting system of FIG. 1, in accordance with one or more example embodiments and/or implementations described herein.

FIG. 9 illustrates still another example portion of the example risk assessment report that can be generated by the non-limiting system of FIG. 1, in accordance with one or more example embodiments and/or implementations described herein.

FIG. 10 illustrates an example process flow diagram of example processes that can be performed by the non-limiting system of FIG. 1, in accordance with one or more example embodiments and/or implementations described herein.

FIG. 11 illustrates a continuation of the example process flow diagram of FIG. 10, in accordance with one or more example embodiments and/or implementations described herein.

FIG. 12 illustrates an example process flow diagram of example processes that can be performed by the non-limiting system of FIG. 1, in accordance with one or more example embodiments and/or implementations described herein.

FIG. 13 illustrates a continuation of the example process flow diagram of FIG. 10, in accordance with one or more example embodiments and/or implementations described herein.

FIG. 14 illustrates a block diagram of an example operating environment into which embodiments of the subject matter described herein can be incorporated.

FIG. 15 illustrates a schematic block diagram of an example computing environment with which the subject matter described herein can interact and/or be implemented at least in part.

### DETAILED DESCRIPTION

### Overview

The technology described herein is generally directed towards, for example, systems, methods and/or computer program products for facilitating quantification and propagation of uncertainties in landslide source, volume, runout and impact, without being limited thereto, at a regional scale.

That is, landslides can pose great risks to human lives and properties worldwide. As a result of climate change, an increasing risk of rain-induced landslides can be expected.

Generally, in existing frameworks, regional landslide early warning systems typically rely on predictions of landslide occurrence based on rainfall thresholds and/or estimation of the number of potential landslides based on rainfall-landslide density. However, consideration of information on landslide hazards alone is inadequate for effective landslide risk management. This can be because a landslide in a densely populated area can cause more severe consequences than a similar landslide in a remote area. Indeed, existing frameworks lack key information inputs, outputs and consideration generations, thus failing to help stakeholders and decision makers in planning for a possible landslide. To help stakeholders and decision makers understand the severity of potential hazards better and take proper actions, the prompt assessment of landslide consequences can be helpful.

In connection therewith, better strategies for landslide emergency management are described in various example embodiments herein, such as including early warning, resource allocation, and emergency response, can be recognized as high-benefit climate change adaptation measures, especially for less developed and vulnerable mountain regions where engineering measures are infeasible.

Accordingly, to account for one or more deficiencies of existing frameworks, the one or more embodiments described herein can provide effective landslide emergency management strategies by employing timely quantitative assessment of likely hazards and losses.

Generally, one or more embodiments described herein can provide a novel and prompt quantitative risk assessment method and/or system for predicting damage, consequences and/or various uncertainties related to rain-induced landslides. The proposed one or more embodiments can automatically generate a risk assessment report, such as a concise one-page report, in a short time span, such as within minutes, to support effective risk communication, resource allocation, and/or emergency response among other uses of such risk assessment report.

To generate data and/or metadata underlying report data provided in the risk assessment report, the propagation of uncertainties can be quantified in a scientific probabilistic framework. The one or more embodiments described herein have been tested using 83 major rainstorms during 1995-2016 in Hong Kong. The one or more embodiments can accurately predict a first quantity of affected economic infrastructure, such as buildings, and/or a second quantity of potential fatalities based on identification, by the one or more embodiments, of rainstorms that can trigger damaging landslides. As a result, the proposed one or more embodiments can contribute to the advancement of landslide emergency management from hazard-informed to risk-informed, which can significantly enhance societal resilience and/or facilitate climate change adaptation.

The one or more example frameworks described herein can be implemented with a low barrier to entry. That is, as alluded to above, the one or more example frameworks can be run on a common computing device, such as a consumer laptop. A landslide risk assessment system described herein can automatically obtain input data and/or metadata, such as rainfall parameters, landslide parameters and/or region parameters. This data can be obtained at any suitable frequency, such as iteratively at a selected frequency. Time to employ the data obtained can be relatively short, thus allowing for provision of one or more (e.g., plural) assessment reports to be generated during a rainstorm, such as dynamically employing changing input data over a course of the rainstorm. Based on these aspects and/or functionalities, the one or more example frameworks described herein can be easily implemented by a common user without deep knowledge of statistical evaluations, landslide physics and/or mathematical probabilities and generation thereof.

### Terminology

As used herein, the terms “cost” or “expense” can refer to power, memory and/or processing power.

As used herein, the term “data” can comprise “metadata.”

Reference throughout this specification to “embodiment,” “one embodiment,” “an embodiment,” “one implementation,” and/or “an implementation,” means that a feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures, or characteristics may be combined in any suitable manner in one or more embodiments/implementations.

As used herein, the terms “employing” or “employed by” can refer to an element (e.g., a hardware device) that is currently being employed, that has already been employed and/or that is to be employed.

As used herein, the term “entity” can refer to a machine, device, smart device, component, hardware, software and/or human. A “user entity,” “client entity” or “administrative entity” can refer to an entity that employs one or more outputs of a system described herein for personal, public, consumer, business and/or commercial use. that stores and accesses data/metadata at a network access storage system.

As used herein, the term “group” can refer to one or more.

A “group of hardware” or “equipment” can refer to a subset of hardware devices of an operation system, which hardware devices can comprise, but are not limited to, storage nodes, switch nodes, server nodes and/or corresponding communication devices, and which operation system can comprise one or more computing systems.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “power” can refer to electrical and/or other source of power available to the operation system.

As used herein, the term “resource” can refer to power, money, memory, CPU bandwidth, processing power, labor, hardware and/or software.

As used herein, the term “set” can refer to one or more.

### Example Architectures

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

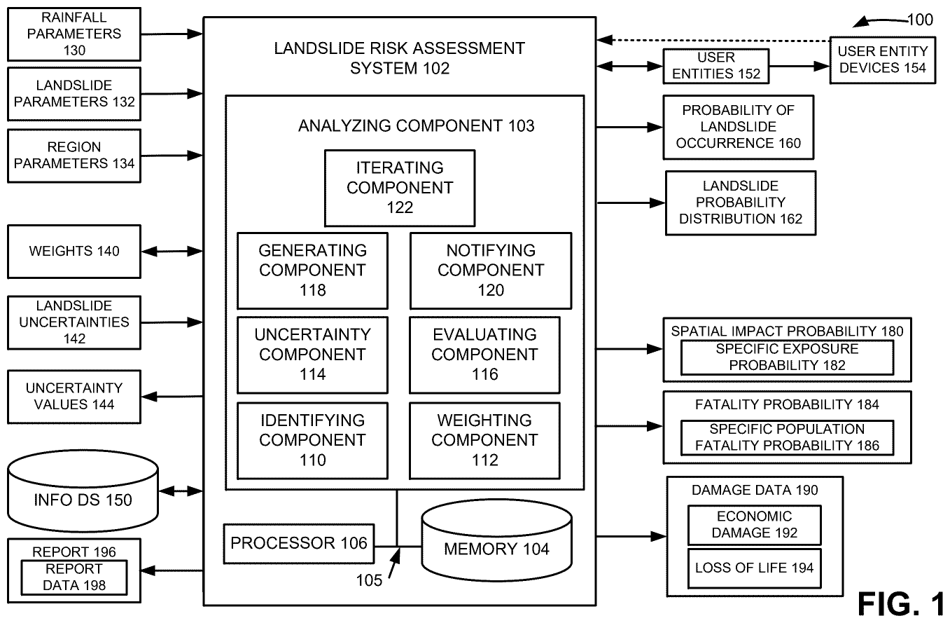

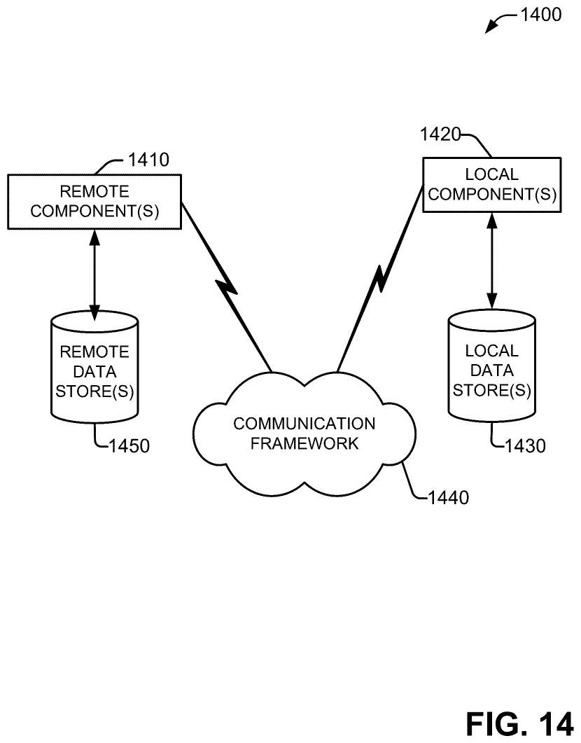

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the operating environment 1400 illustrated at FIG. 14. In one or more described embodiments, computer and/or computing-based elements can be used in connection with implementing one or more of the systems, devices, components and/or computer-implemented operations shown and/or described in connection with FIGS. 1-13 and/or with other figures described herein.

Turning now in particular to one or more figures, and first to FIG. 1, illustrated is a block diagram of an example, non-limiting system 100 that can facilitate quantification of uncertainties relating to a possibility of a landslide, and based thereon, can automatically generate one or more probability values defining one or more consequences of one or more probable landslides, and which also can generate one or more damage quantifications defining one damage to infrastructure and/or loss of life (e.g., fatalities).

FIG. 1 illustrates the non-limiting system 100 comprising a landslide risk assessment system 102 that can function to generally provide one or more processes for executing the quantification and generation processes noted directly above. Generally, the landslide risk assessment system 102 can provide for consideration of uncertainties relative to input parameters (e.g., region parameters, landslide parameters, rainfall parameters), can generate a comprehensive predicted indicator of hazards including rainstorms that can trigger damaging landslides, can generate comprehensive predicted indicators of losses including affected property and/or potential fatalities, and/or can automatically generate a comprehensive risk assessment report in real-time, allowing for proactive risk communication, resource allocation and/or emergency response.

In one or more embodiments, the non-limiting system 100, as illustrated, can further comprise an information datastore 150 (info ds 150 at FIG. 1) that can comprise any suitable hardware, software and/or firmware for providing at least storage and/or recall of information comprising data and/or metadata. The information datastore 150 can be comprised by, and/or be external to, the landslide risk assessment system 102 and/or non-limiting system 100, such as at least being communicatively accessible by the landslide risk assessment system 102.

Generally, the landslide risk assessment system 102 can comprise any suitable computing devices, hardware, software, operating systems, drivers, network interfaces and/or so forth. As illustrated, the landslide risk assessment system 102 can comprise an identifying component 110, weighting component 112, uncertainty component 114, evaluating component 116, generating component 118, notifying component 120 and/or iterating component 122. These components can be comprised by a processor 104, and/or one or more of these components can be external to the processor 104, or a combination thereof. A bus 105 can operatively couple the processor 104 and a memory 106.

Communication among the components of the landslide risk assessment system 102 can be by any suitable method. Communication can be facilitated by wired and/or wireless methods including, but not limited to, employing a cellular network, a WAN (e.g., the Internet), and/or a LAN. Suitable wired or wireless technologies for facilitating the communications can include, without being limited to, Wi-Fi, GSM, UMTS, WiMAX, enhanced GPRS, 3GPPLTE, 3GPP2UMB, HSPA, ZIGBEE®and other 802.XX wireless technologies and/or legacy telecommunication technologies, BLUETOOTH®, SIP, RF4CE protocol, WirelessHART protocol, 6LoWPAN, Z-Wave, an ANT protocol, a UWB standard/protocol and/or other proprietary and/or non-proprietary communication protocols.

Discussion first turns to the processor 104, memory 106 and bus 105 of the landslide risk assessment system 102.

In one or more embodiments, the landslide risk assessment system 102 can comprise a processor 104 (e.g., computer processing unit, microprocessor, classical processor and/or like processor). In one or more embodiments, the processor 104 can be and/or be comprised by a controller.

In one or more embodiments, a component (which also can be referred to as a module) associated with landslide risk assessment system 102, as described herein with or without reference to the one or more figures of the one or more embodiments, can comprise one or more computer and/or machine readable, writable and/or executable components and/or instructions that can be executed by processor 104 to facilitate performance of one or more processes defined by such component and/or instructions.

In one or more embodiments, the landslide risk assessment system 102 can comprise a machine-readable memory 106 that can be operably connected to the processor 104. The memory 106 can store computer-executable instructions that, upon execution by the processor 104, can cause the processor 104 and/or one or more other components of the landslide risk assessment system 102 to perform one or more actions. In one or more embodiments, the memory 106 can store computer-executable components.

The landslide risk assessment system 102 and/or a component thereof as described herein, can be communicatively, electrically, operatively, optically and/or otherwise coupled to one another via a bus 105 to perform functions of non-limiting system architecture 100, landslide risk assessment system 102 and/or one or more components thereof and/or coupled therewith. Bus 105 can comprise one or more of a memory bus, memory controller, peripheral bus, external bus, local bus and/or another type of bus that can employ one or more bus architectures. One or more of these examples of bus 105 can be employed to implement one or more embodiments described herein.

In one or more embodiments, landslide risk assessment system 102 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the landslide risk assessment system 102 can reside in the cloud, and/or can reside locally in a local computing environment (e.g., at a specified location).

In addition to the processor 104 and/or memory 106 described above, the landslide risk assessment system 102 can comprise one or more computer and/or machine readable, writable and/or executable components and/or instructions that, when executed by processor 104, can facilitate performance of one or more operations defined by such component and/or instruction.

It is noted that, in one or more embodiments, the identifying component 110, weighting component 112, uncertainty component 114, evaluating component 116, generating component 118, notifying component 120 and/or iterating component 122 can be implemented independently, without one or more other of the identifying component 110, weighting component 112, uncertainty component 114, evaluating component 116, generating component 118, notifying component 120 and/or iterating component 122. Additionally and/or alternatively, the identifying component 110, weighting component 112, uncertainty component 114, evaluating component 116, generating component 118, notifying component 120 and/or iterating component 122 can be comprised by a high-level analyzing component 103, one or more of the below-described functions of the identifying component 110, weighting component 112, uncertainty component 114, evaluating component 116, generating component 118, notifying component 120 and/or iterating component 122 can be performed by the high-level analyzing component 103, and/or one or more of the identifying component 110, weighting component 112, uncertainty component 114, evaluating component 116, generating component 118, notifying component 120 and/or iterating component 122 can be omitted with the high-level analyzing component 103 performing one or more of the below-described functions of the one or more omitted identifying component 110, weighting component 112, uncertainty component 114, evaluating component 116, generating component 118, notifying component 120 and/or iterating component 122.

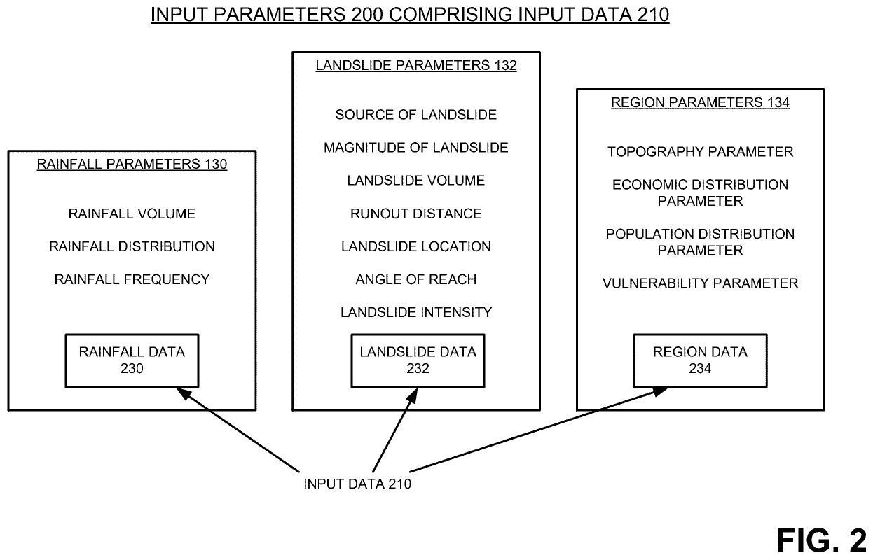

Direction now turns first to the identifying component 110, as well as to both FIGS. 1 and 2. This component can identify a plurality of different input data 210 (e.g., which can comprise data and/or metadata) that can define a set of input parameters 200. This information can be obtained automatically, by request, by searching, etc., by the identifying component 100 using any suitable database that can be accessed and/or communicatively coupled to the landslide risk assessment system 102. For example, in one or more example embodiments, data gathering can be at least partially automatically gathered, such as by connecting to a rain gauge network comprising rainfall information, topography network comprising region topography information, and/or region census network comprising region economic property and/or population information.

Input data 210 can define input parameters 200. Input data can comprise rainfall data 230, landslide data 232 and region data 234. This rainfall data 230, landslide data 232 and/or region data 234 data can be real-time, historical and/or predicted. Input parameters 200 can comprise rainfall parameters 130, landslide parameters 132 and/or region parameters 134. Rainfall data 230 can specifically define the rainfall parameters 130 including, but not limited to, rainfall amount, rainfall distribution and/or rainfall update frequency. Landslide data 232 can specifically define the landslide parameters 132 including, but not limited to, source of landslide, magnitude of landslide, landslide volume, runout distance, landslide location, angle of reach. Region data 234 can specifically define the region parameters 134 including, but not limited to, topography parameters, economic distribution parameters, population distribution parameters and/or vulnerability parameters.

The term “runout,” as used herein, can refer to a horizontal projection of a distance connecting an upper portion of the landslide source area to a farthest edge of movement of associated landslide material comprised by a landslide.

The term “vulnerability,” as used herein, and as according to the United Nations Office for Disaster Risk Reduction (UNDRR) can refer to the characteristics and circumstances of a community, system or asset that make it susceptible to the damaging effects of a hazard.

Based on the input data 210 gathered by the identifying component 110, the weighting component 112 can generally generate one or more weights 140 that can be applied to any one or more of the various ones of the rainfall parameters 130, landslide parameters 132 and/or region parameters 134 discussed above.

For example, weights 140 for region parameters 134 can be based on a defining topography of the land region. For example, a first region having a topography having a high sloped area can have a greater weight 140 applied to a topography parameter for that first region than a second region having a topography having low sloped areas. Likewise, a region having low lying basin or valley areas can have a greater weight 140 than regions not comprising such low lying basin or valley areas.

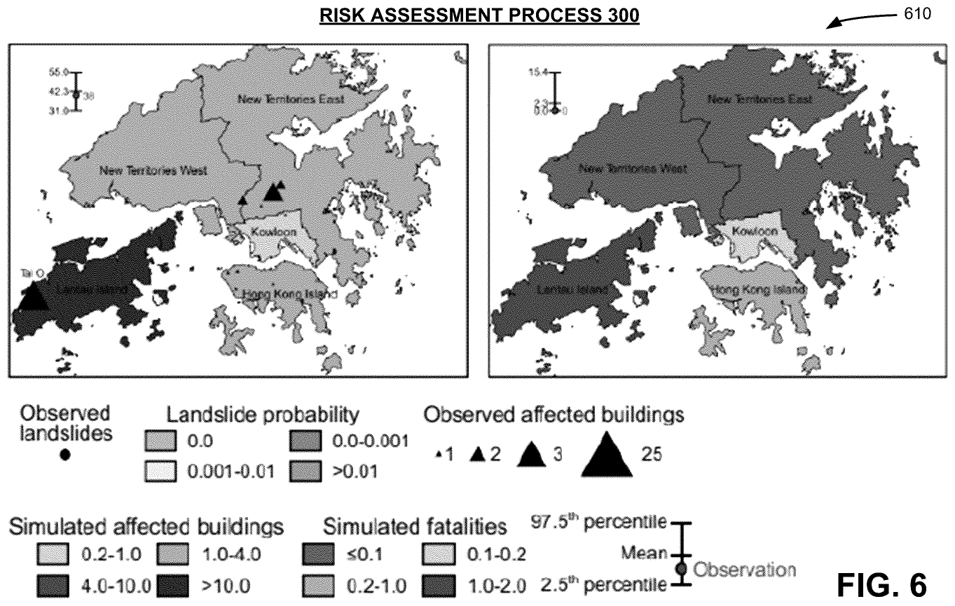

For another example, the weighting component 112 can assign one or more weights 140 to landslide uncertainties 142 corresponding to landslide parameters 132, such as based on region parameters 134 for a land region 400 (FIG. 6). That is, one or more landslide parameters 132 can be less than exactly definable, and thus can instead be defined as one or more landslide uncertainties 142. For example, a landslide uncertainty 142 can be a prediction of a landslide runout parameter. A weight 140 can be assigned to a landslide uncertainty 142 to modify the value and/or quantity employed to define the landslide uncertainty 142. As noted, such weight 140 can be based on a region parameter 134 defining a region 400 at which the landslide runout is predicted. For example, a value and/or quantity corresponding to a topography region parameter 134 can be employed to determine a weight 140, such as by the system 102. In one case, a topography parameter based on a high elevation and/or high slope region can allow for a greater weight 140 to be applied than a weight 140 instead associated with a topography parameters based on a low elevation and/or low slope region.

As used herein, weights 140 can be percentages, numbers, etc. that can be employed to modify a value and/or quantity of an input parameter 200. Accordingly, an input parameter 200 can be represented by any suitable value, number, quantity, etc., in any suitable range.

The weighted parameters resulting from application of the weights 140 to the parameters 130, 132, 134 can be employed for a risk assessment process 300 that can be performed by at least the uncertainty component 114 and/or evaluating component 116 of the landslide risk assessment system 102.

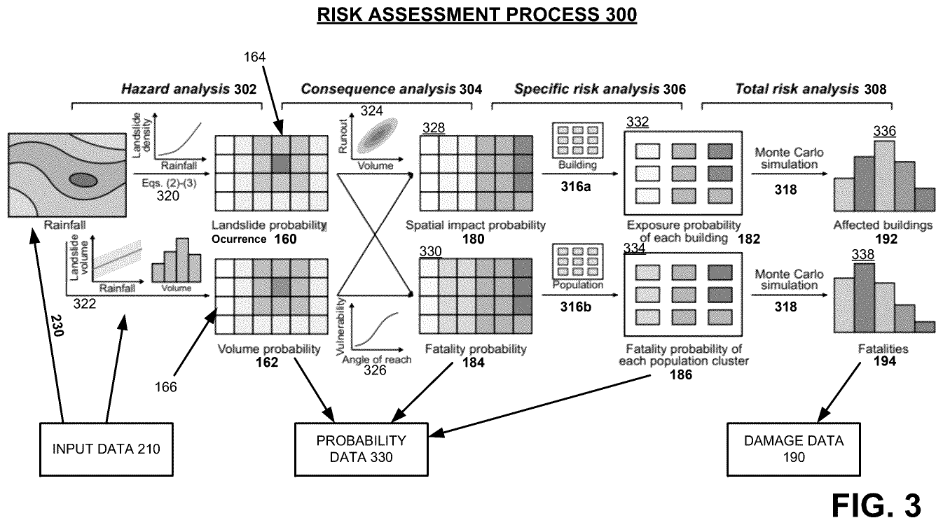

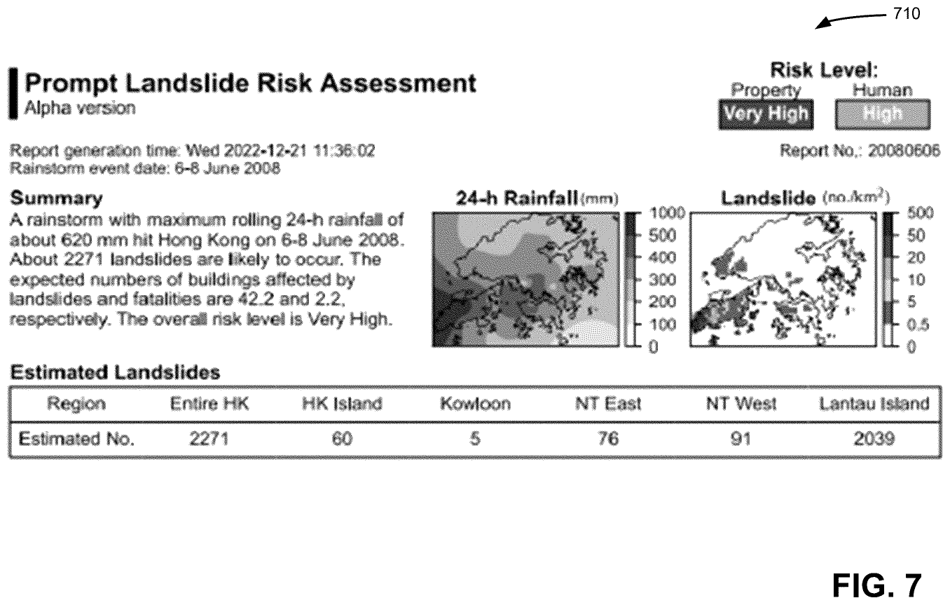

Direction next turns to a risk assessment process 300, illustrated at FIG. 3, that can be performed by the landslide risk assessment system 102 of FIG. 1 using the input parameters 200 illustrated at FIG. 2, without being limited to the particular input parameters 200 listed. Generally, this risk assessment process 300 provides an operational platform using an end-to-end framework that can execute landslide hazard analysis 302, consequence analysis 304, risk analyses 306, 308 and/or comprehensive report generation (FIGS. 7-9). The uncertainty component 114 can provide the hazard analysis 302 and consequence analysis 304, while the evaluating component 116 can provide the risk analyses 306 and 308. Using outputs of these analyses 302-308, the generating component 118 can generate a comprehensive risk assessment report 196 comprising report data 198, and the notifying component 120 can determine what entities to inform regarding the report data 198.

In one or more embodiments, the components described above can perform the risk assessment process 300 by employing an object-oriented, high-level programming language, such as having dynamic semantics. The components can generally, without being limited thereto, take a maximum rolling 24-hour rainfall observed at selected rain gauges or a short-term forecasted rainstorm process as real-time input, and provide an output of an automatically generated brief (e.g., one-page) report that summarizes information about the rainstorm, predicted landslides, and/or risk distribution.

The risk assessment process 300 can be executed on a personal computer device efficiently. For example, an associated simulation time for a region of all of Hong Kong (˜1,100 km2) with 10,000 Monte Carlo samples can take about 3 min on a personal computer device having a CPU of Core i7-7700@3.60 GHz. This example computational efficiency can meet a need for landslide warning and timely landslide risk management. That is, using the landslide risk assessment system 102 described herein, the proposed landslide risk assessment method can be deployed for landslide warning with limited effort. An entity can merely update the maximum rolling 24-hour rainfall based on dynamic (e.g., progressing in real-time) observations or nowcasts of rainfall and can request repeating of the assessment until rainfall ceases. In one or more example embodiments, a fully automated risk-informed landslide warning system can be established by connecting the developed program with an automated rain gauge network, as described above relative to the identifying component 110. @

Turning now to specifics of FIG. 3, and first to the example hazard analysis 302, such hazard analysis 302 can be performed by the uncertainty component 114. The uncertainty component 114 can generally quantify propagation of uncertainties in landslide parameters 132 over a specified range of time that is within about 1 day from (e.g., about 24 hours or less before) a current time (e.g., a time of performing the risk assessment process 300), resulting in quantified uncertainty values 142. This quantifying can be based on the rainfall data 230 (e.g., on the rainfall parameters 130) and the set of region parameters 134, therefore allowing for assessing probability of landslide occurrence 160.

For example, an output of landslide occurrence probability 160 can be based on evaluation and/or comparison 320 of landslide density (e.g., a landslide parameter 132) to rainfall (e.g., rainfall data 230). Landslide occurrence probability 160 can be defined as the probabilities associated with the prediction of varying landslide occurrences over unit of rainfall (e.g., rainfall amount, distribution, etc.) In one or more cases, the landslide parameters 132 of landslide density can have been weighted by the weighting component 112 and thus can be a weighted landslide parameter 132 used for the evaluation and/or comparison. In one or more cases, the landslide occurrence probability 160 can be represented and/or output as a generated landslide probability distribution graph 164, as illustrated at FIG. 3. As a result of the evaluation and/or comparison 320, the uncertainty component 114 can generate the landslide probability distribution graph 164.

In another example, a landslide volume probability 162 can be based on evaluation and/or comparison 322 of landslide volume and/or landslide density (e.g., another landslide parameter 32) to rainfall (e.g., rainfall data 230). Landslide volume probability 162 can be defined as the probabilities associated with the prediction of varying landslide volumes (e.g., volume of material in the landslides). In one or more cases, the landslide parameters 132 of landslide density can have been weighted by the weighting component 112 and thus can be a weighted landslide parameter 132 used for the evaluation and/or comparison. In one or more cases, the landslide volume probability 162 can be represented and/or output as a generated landslide volume distribution graph 166, as illustrated at FIG. 3. As a result of the evaluation and/or comparison 322, the uncertainty component 114 can generate the landslide volume distribution graph 166.

In one or more cases, the landslide volume probability 162 and/or landslide occurrence probability 160 can be observed as and/or comprise probability data 330. That is, probability data 330 can result from input data 210.

Turning now to the consequence analysis 304 and to the evaluating component 116, this component can generally, based on the set of region parameters 134 and the probability of landslide occurrence 160, generate damage data 190 defining economic damage over a specified range of time that is within about 1 day from (e.g., 24 or less hours in advance of) a current time (e.g., a time of performing the risk assessment process 300), and/or generate damage data 190 defining loss of life over the same or different specified range of time that is within about 1 day from (e.g., 24 or less hours in advance of) a current time (e.g., a time of performing the risk assessment process 300).

For example, an output of spatial impact probability 180 can be based on a first evaluation and/or comparison 324 of landslide runout (e.g., a landslide parameter 132) to landslide volume (e.g., another landslide parameter 132) and/or on a second evaluation and/or comparison 326 of region vulnerability (e.g., a region parameter 134) to angle of reach (e.g., a landslide parameter 132). Spatial impact probability 180 can be defined as the probabilities associated with the prediction of varying runout distances vs. varying landslide volumes and/or of varying vulnerabilities vs. varying angles of reach, as related to a region parameter 134 of population density. In one or more cases, the landslide parameters 132 of landslide density can have been weighted by the weighting component 112 and thus can be a weighted landslide parameter 132 used for the evaluation and/or comparison. For example, weights 140 can be employed for particular landslide volume parameters (e.g., particular landslide volumes) such as based on a topography parameter. In one or more cases, the spatial impact probability 180 can be represented and/or output as a generated spatial impact probability distribution graph 328, as illustrated at FIG. 3. As a result of the evaluation and/or comparison 324 and/or 326, the uncertainty component 114 can generate the spatial impact probability distribution graph 328.

For another example, an output of a fatality probability 184 can be based on a first evaluation and/or comparison 324 of landslide runout (e.g., a landslide parameter 132) to landslide volume (e.g., another landslide parameter 132) and/or on a second evaluation and/or comparison 326 of region vulnerability (e.g., a region parameter 134) to angle of reach (e.g., a landslide parameter 132). Fatality probability 184 can be defined as the probabilities associated with the prediction of varying runout distances vs. varying landslide volumes and/or of varying vulnerabilities vs. varying angles of reach, as related to a region parameter 134 of building density or economic distribution. In one or more cases, the landslide parameters 132 of landslide density can have been weighted by the weighting component 112 and thus can be a weighted landslide parameter 132 used for the evaluation and/or comparison. For example, weights 140 can be employed for particular landslide angle of reach parameters (e.g., particular landslide angles of reach) such as based on a topography parameter. In one or more cases, the fatality probability 184 can be represented and/or output as a generated fatality probability distribution graph 330, as illustrated at FIG. 3. As a result of the evaluation and/or comparison 324 and/or 326, the uncertainty component 114 can generate the fatality probability distribution graph 330.

Turning now to the specific risk analysis 306 and to the evaluating component 116, this component can generally, based at least on the set of region parameters 134 and the probability of landslide occurrence 160, generate damage data 190 defining economic damage over a specified range of time that is within about 1 day from (e.g., 24 or less hours in advance of) a current time (e.g., a time of performing the risk assessment process 300), and/or generate damage data 190 defining loss of life over the same or different specified range of time that is within about 1 day from (e.g., 24 or less hours in advance of) a current time (e.g., a time of performing the risk assessment process 300). More particularly, property damage data 190 can be based on the spatial impact probability 180 and/or fatality damage data 190 can be based on the fatality probability 184.

For example, an output of exposure probability 182, for one or more buildings 316a, can be based on spatial impact probability 180 as applied to the one or more buildings 316a (e.g., to data corresponding to the one or more buildings 316a, such as describing structure type, size, location, etc.). Accordingly, the exposure probability 182 can be defined as the probabilities associated with the prediction of damage to various ones of the buildings 316a. In one or more cases, the exposure probability 182 can be represented and/or output as a generated exposure probability distribution graph 332, as illustrated at FIG. 3, which can be generated by the evaluating component 116.

For another example, an output of specific fatality probability 186, for one or more population cluster 316b, can be based on fatality probability 184 as applied to the one or more population clusters 316b (e.g., to data corresponding to the one or more population clusters 316b, such as describing population density, quantity, height/vertical distribution, etc.). Accordingly, the specific fatality probability 186 can be defined as the probabilities associated with the prediction of damage (e.g., loss of life) to various ones of the population clusters 316b. In one or more cases, the specific fatality probability 186 can be represented and/or output as a generated fatality probability distribution graph 334, as illustrated at FIG. 3, which can be generated by the evaluating component 116.

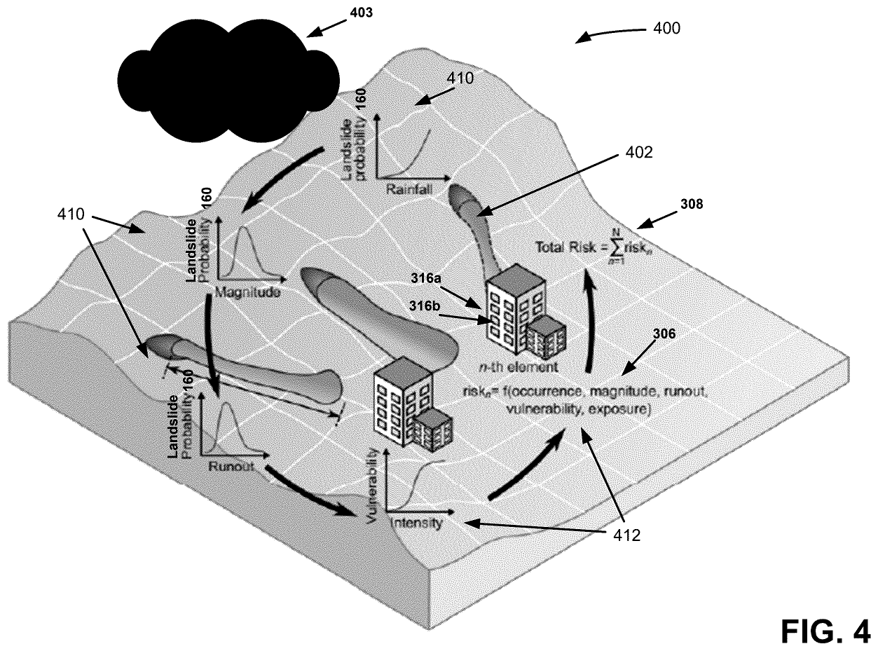

That is, in one or more embodiments, the evaluating component 116 can assign respective probabilities 182, 186 for a first quantity of affected properties (e.g., buildings 316a loss relative to exposure probabilities 182) or a second quantity of losses of life (e.g., population 316b loss relative to specific fatality probability 186) at different time points of a group of time points. For example, the evaluating component 116 can provide such benchmarks at even and/or non-even distribution of time points over a specified range of time, such as an hour or more after start of a rainstorm 403 (FIG. 4).

Relative to the risk assessment process 300, direction turns last to total risk analysis 308. Generally, the evaluating component 116 can provide damage data 190 defining affected buildings 316a and/or populations 316b. Put another way, the damage data 190 can result from the probability data 330.

That is, the evaluating component 116 can generally perform a simulation using a computational approach that employs repeated random sampling to obtain a likelihood of occurrence of a range of results. For example, a Monte Carlo simulation 318 can be employed by the evaluating component 116, using the exposure probability 182 to generate a first distribution 192 of affected buildings 316a, such as of various types, locations, construction materials, etc. including a first quantity of losses of property. Likewise, a Monte Carlo simulation 318 can be employed by the evaluating component 116, using the specific fatality probability 186 to generate a second distribution 194 of affected populations 316b, such as of various densities, locations, vulnerabilities, economic classes, etc. including a second quantity of losses of life.

As a brief summary, attention is directed next to the illustrated land region 400 of FIG. 4 and the sub-illustrations detailed therein. As shown, a rainstorm 403 can cause one or more landslides 402, affecting one or more buildings 316a and/or populations 316b. Based on the probability of landslide occurrence 160 generated by the uncertainty component 114, the uncertainty component can further provide data defining more specific probabilities of landslides, such as based on one or more comparisons of probability of landslide occurrence 160 to one or more of rainfall data 230, predicted landslide magnitude and/or predicted landslide runout. In one or more cases, predicted landslide magnitude and/or predicted landslide runout can be weighted landslide parameters 132 such as based on topographical region data 234. These various determinations 410 by the uncertainty component 114 can be performed at least partially in parallel with one another, rather than explicitly in series as illustrated at FIG. 4.

As used herein, the term “landslide magnitude” can refer to a destructive power that can be characterized by intensity.

These various determinations 410 by the uncertainty component 114 can be employed to perform one or more additional risk assessments 412, such as comparison of one or more vulnerabilities (e.g., a region parameter 134) to one or more predicted landslide intensities (e.g., a landslide parameter 132), and/or such as one or more specific risk analyses 306, which can be employed to generate the one or more total risk analyses 308, by the evaluating component 116.

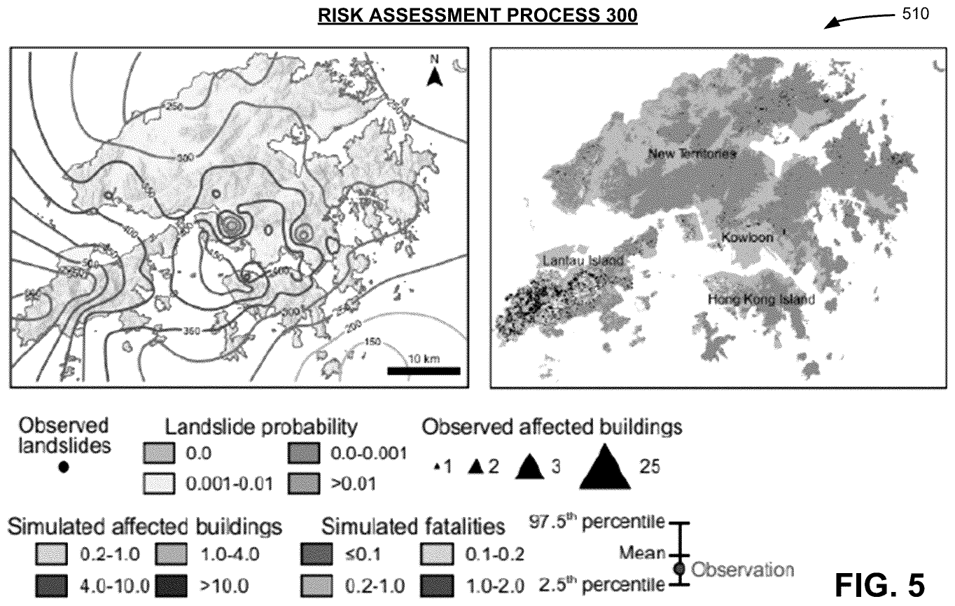

Turning to the examples of FIGS. 5 and 6, illustrated are example applications of the landslide risk assessment system 102 described herein to historical rainstorms, such as using historical data at one or more information datastores 150 communicatively coupled to the landslide risk assessment system 102. For example, relative to rainfall data 230 for a rainstorm having occurred on Jun. 6-8, 2008, in Hong Kong, the following input data 210 were employed: (a) maximum rolling 24-h rainfall amount (mm); (b) observed landslides in 2008 and simulated landslide probability (cell size=20 m×20 m) during the rainstorm on Jun. 6-8, 2008; (c) observed and simulated affected buildings; and/or (d) observed and simulated fatalities. It is noted that legends in the upper-left corners of (c) and (d) are the statistics of Monte Carlo simulation samples generated for all of Hong Kong. (Data from HKSARG [Government of Hong Kong Special Administrative Region], 2022a, “Digital terrain model,” Last Accessed Dec. 27, 2022, https://data.gov.hk/en-data/dataset/hk-landsd-openmap-5m-grid-dtm and/or HKSARG [Government of Hong Kong Special Administrative Region], 2022b, “LandsD topographic map,” Last Accessed Dec. 27, 2022, https://data.gov.hk/en-data/dataset/hk-landsd-openmap-landsd-topo-map-api.)

Referring next to FIGS. 7 to 9, illustrated are portions of a comprehensive risk assessment report 196, broken into three pages of figures to allow for more detailed viewing of the illustrations. It is noted that the illustrations of all three FIGS. 7 to 9 can be provided at a single page, one-sided comprehensive report, in one or more examples.

At FIG. 7, illustrated is a concise initial information portion 710 of an example report 196 that can be generated by the generating component 118. The concise initial information portion 710 can comprise any one or more of time of generation, report identification number, rainstorm time, general risk level to property and/or population, and/or a brief summary of the hazard analysis 302, consequence analysis 304, specific risk analysis 306 and/or total risk analysis 308. For example, such summary can be limited to five or fewer sentences, such as a single paragraph.

One or more depictions can be provided at the portion 710, such as illustrating distributed rainfall and/or distributed landslide probability (e.g., distribution of landslide probability occurrence 164).

In one or more cases, this distribution 164 can be represented as a list, table and/or matrix with one or more identified locations within a region being monitored (e.g., the Estimated Landslides table at FIG. 7).

In one or more cases, the general risk level to property and/or population can be color coded based on severity and/or can be based on the first and/or second quantities of damage data 190 discussed above, such as relative to respective property damage and/or loss of life (e.g., population damage) thresholds.

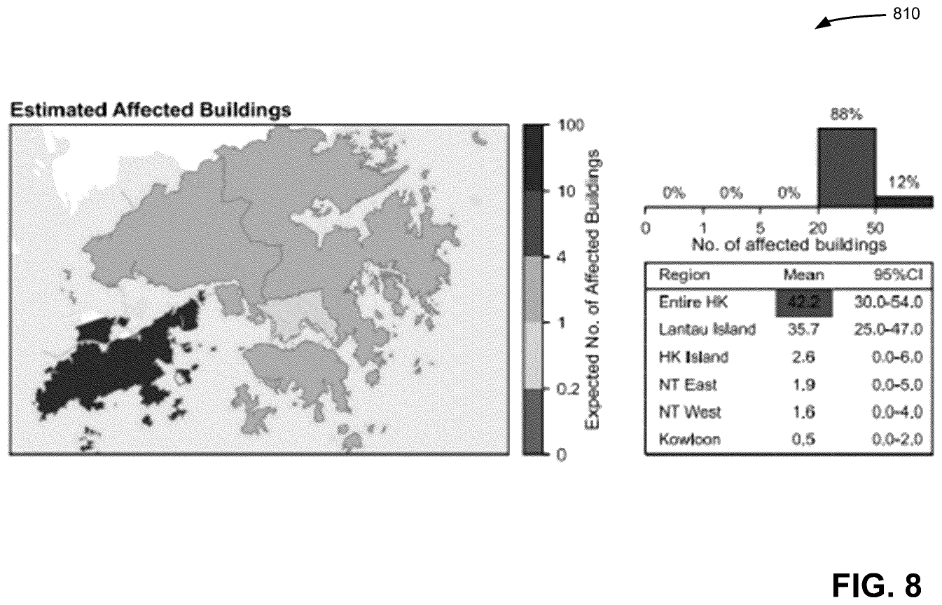

At FIG. 8, illustrated is a concise economic property damage portion 810 of the example report 196 that can be generated by the generating component 118 based on the probability data 330 and damage data 190. As illustrated, this portion 810 can comprise a graphical depiction of the exposure probability distribution 332 relative to the region 400. In one or more cases, this distribution 332 can be represented as a list, table and/or matrix with one or more identified locations within a region being monitored (e.g., the No. of affected buildings table at FIG. 8).

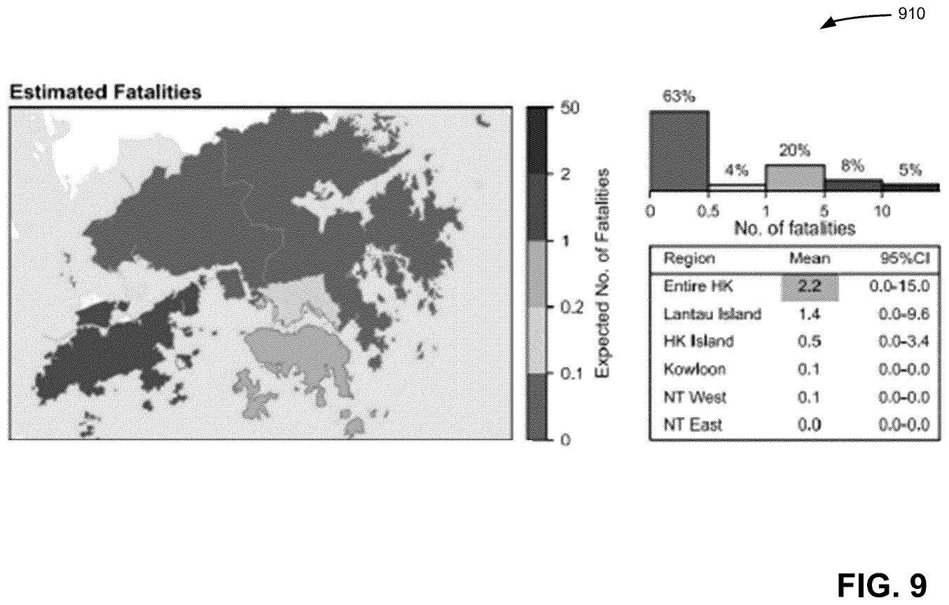

At FIG. 9, illustrated is concise fatality portion 910 of the example report 196 that can be generated by the generating component 118 based on the probability data 330 and damage data 190. As illustrated, this portion 910 can comprise a graphical depiction of the specific fatality probability distribution 334 relative to the region 400. In one or more cases, this distribution 334 can be represented as a list, table and/or matrix with one or more identified locations within a region being monitored (e.g., the No. of fatalities table at FIG. 9).

Accordingly, as illustrated at FIGS. 7 to 9, the generating component 118 can, based on the output probability data 330 and/or damage data 190, generate report data 198 and format the report data 198 into a concise assessment report 196, such as comprising the three portions 710, 810 and 910 illustrated at FIGS. 7 to 9. Put another way, the generating component 118 can generate report data 198 representative of a landslide occurrence comprising probability data 330 indicative of the probability of landslide occurrence 160. In one or more cases, different from the illustrations of FIGS. 7 to 9, this report data 198 can be generated and/or formatted into a report 196 comprising probability data 330 and/or damage data 190 as predicted over a specified range of time, such as broken down into one or more even and/or uneven timepoints of the specified range of time.

Generally, the assessment report 196 can comprise any one or more of uncertainty data indicative of the quantified uncertainty values discussed herein, graphs, illustrations, probabilities (e.g., probability data 330) and/or damage data 190. In one or more cases, economic impact (e.g., property impact) can be visually separated from loss of life impact.

That is, as illustrated at FIGS. 7 to 9, the report data 198 can define one or more landslide uncertainties 142 comprising at least one of landslide source data 232 indicative of a source of the landslide, landslide volume data indicative of a volume of the landslide, and/or landslide runout data indicative of a runout distance of the landslide.

Turning again briefly to FIG. 1, the notifying component 120 can generally transmit the report data 198 and/or a report 196 to a consumer device. For example, the notifying component 120 can transmit the report data 198 to at least one administrative service corresponding to the land region 400, comprising sending the report data 198 to at least one device associated with the at least one administrative service. Accompanying the report data 198 and/or comprised by the report data 198 can be at least one recommended action to initiate determined based on the report data 198. For example, an example recommended action to initiate can be an evacuation, assignment of resources, initiation of an emergency protocol, etc.

The iterating component 122 can generally iteratively repeat (e.g., and/or direct repeating of) any one or more of the input data 210 gathering, analyses 302-308 of the risk assessment process 300, and/or generation of report data 198. For example, the iterating component 122 can direct any one or more of the identifying component 110, weighting component 112, uncertainty component 114, evaluating component 116, generating component 118 and/or notifying component 120 to perform any one or more operations discussed above as being able to be performed by these one or more components 110 to 120.

As used here, the term “iteratively” can refer to repeat direction at a specified frequency, such as a default specified frequency and/or a frequency based on rainfall data 230. These repeat iterations can be continued, by the iterating component 122, until rainfall data 230 and/or landslide occurrence probability 160 satisfies a respective rainfall data and/or landslide occurrence probability threshold. As a result, continued updates of assessment reports 196 and/or assessment report data 198 can continue to be iteratively generated and/or transmitted by the generating component 118 and/or notifying component 120, respectively.

### Example Operations

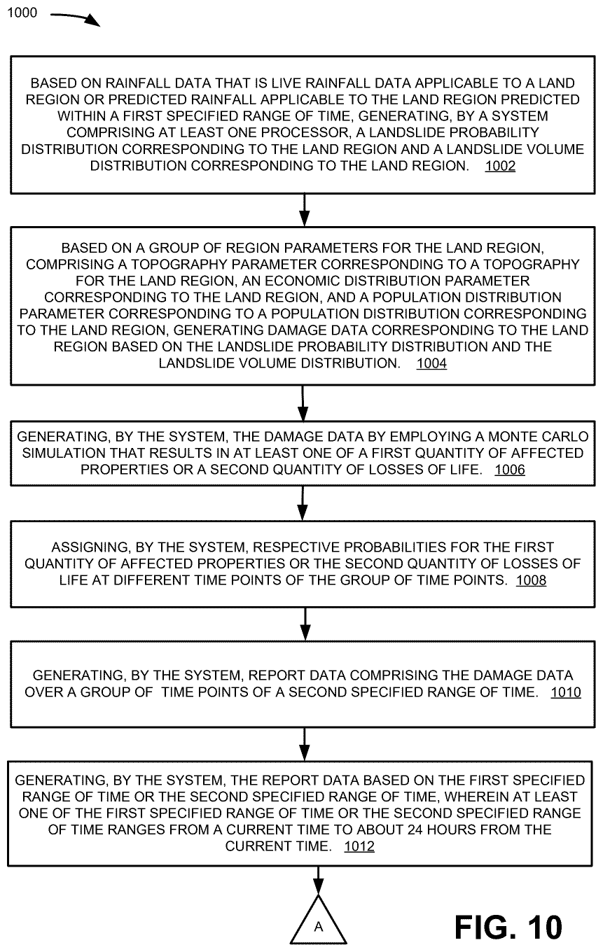

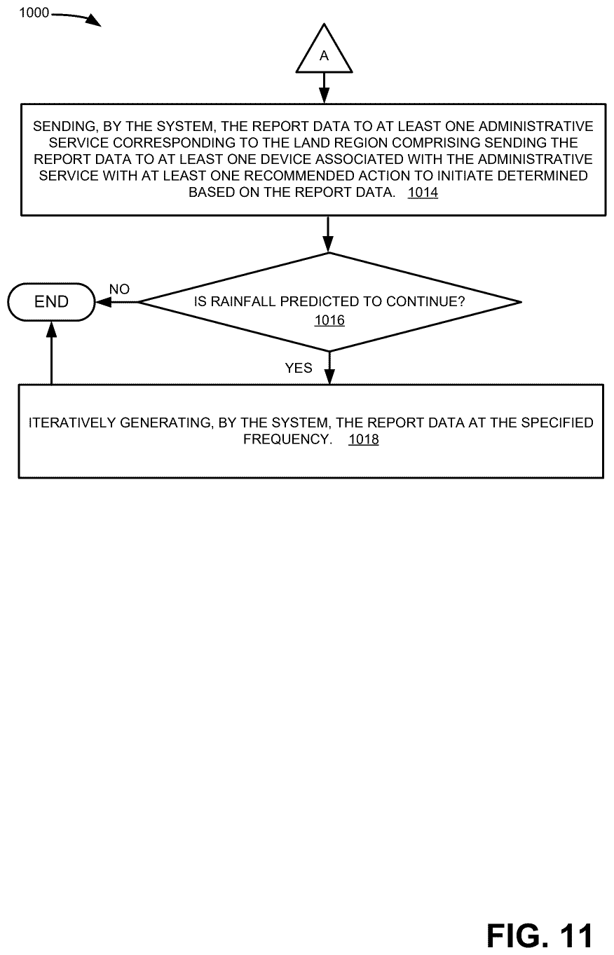

As a first summary of the above description provided relative to FIGS. 1-9, turning now to FIGS. 10 and 11, an example process flow 1000 can comprise a set of operations for evaluating probability of landslide occurrence, risk and/or damage. One or more elements, objects and/or components referenced in the process flow 1000 can be those of FIGS. 1-9. Repetitive description of like elements and/or processes employed in previously described embodiments is omitted for sake of brevity.

At operation 1002, the process flow 1000 can comprise, based on rainfall data (e.g., rainfall data 230) that is live rainfall data applicable to a land region (e.g., land region 400) or predicted rainfall applicable to the land region predicted within a first specified range of time, generating, by a system (e.g., uncertainty component 114) comprising at least one processor (e.g., processor 106), a landslide probability distribution (e.g., landslide probability distribution 164) corresponding to the land region and a landslide volume distribution (e.g., landslide volume distribution 162) corresponding to the land region.

At operation 1004, the process flow 1000 can comprise, based on a group of region parameters (e.g., region parameters 134) for the land region, comprising a topography parameter corresponding to a topography for the land region, an economic distribution parameter corresponding to the land region, and a population distribution parameter corresponding to a population distribution corresponding to the land region, generating damage data (e.g., damage data 190) corresponding to the land region based on the landslide probability distribution and the landslide volume distribution.

At operation 1006, the process flow 1000 can comprise generating, by the system (e.g., evaluating component 116), the damage data by employing a Monte Carlo simulation (e.g., Monte Carlo simulation 318) that results in at least one of a first quantity of affected properties (e.g., affected buildings 192) or a second quantity of losses of life (e.g., fatalities 194).

At operation 1008, the process flow 1000 can comprise assigning, by the system (e.g., uncertainty component 114) respective probabilities for the first quantity of affected properties (e.g., exposure probability of each building 182) or the second quantity of losses of life (e.g., fatality probability of each population cluster 186) at different time points of the group of time points.

At operation 1010, the process flow 1000 can comprise generating, by the system (e.g., generating component 118), report data (e.g., report data 198) comprising the damage data over a group of time points of a second specified range of time.

At operation 1012, the process flow 1000 can comprise generating, by the system (e.g., generating component 118), the report data based on the first specified range of time or the second specified range of time, wherein at least one of the first specified range of time or the second specified range of time ranges from a current time to about 24 hours from the current time.

At operation 1014, the process flow 1000 can comprise, sending, by the system (e.g., notifying component 120) the report data to at least one administrative service corresponding to the land region comprising sending the report data to at least one device associated with the administrative service with at least one recommended action to initiate determined based on the report data.

At operation 1016, the process flow 1000 can comprise determining whether the rainfall is predicted to continue. If yes, the process flow 1000 can proceed to operation 1024. If not, the process flow 1000 can end.

At operation 1018, the process flow 1000 can comprise iteratively generating, by the system (e.g., generating component 118 with and/or without direction of the iterating component 122), the report data at the specified frequency.

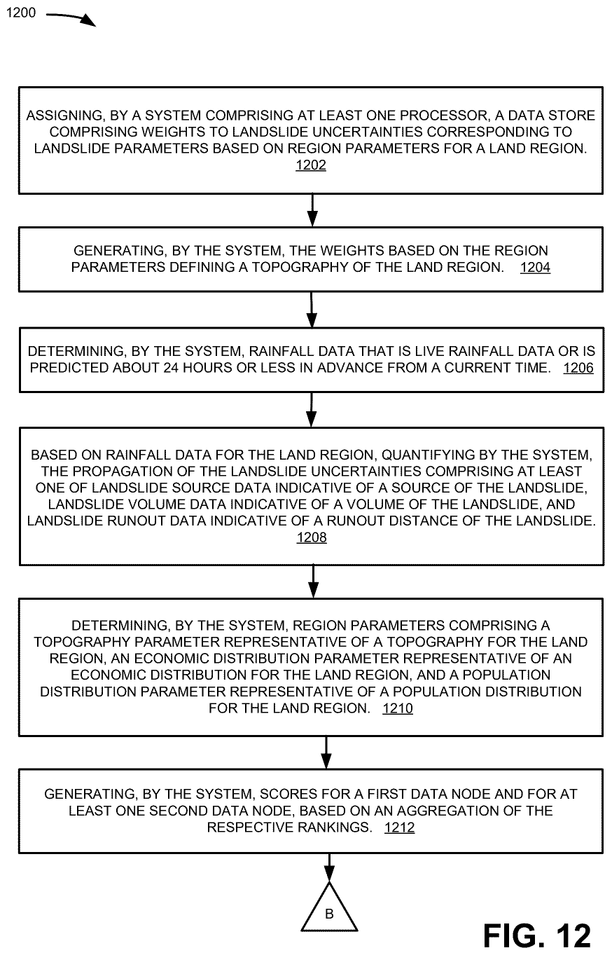

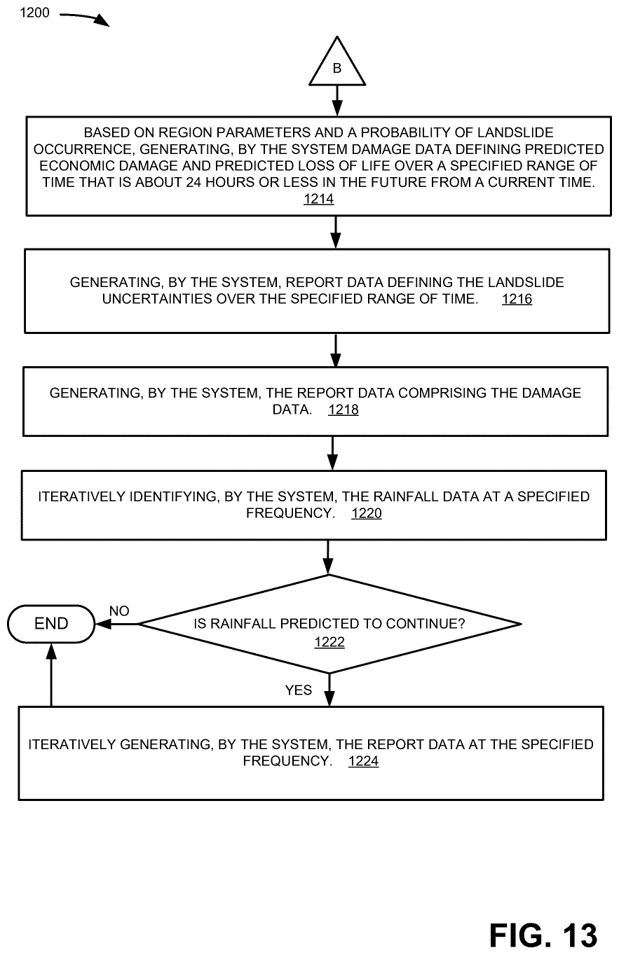

As a second summary of the above description provided relative to FIGS. 1-9, turning now to FIGS. 12 and 13, another example process flow 1200 can comprise a set of operations for evaluating probability of landslide occurrence, risk and/or damage. One or more elements, objects and/or components referenced in the process flow 1200 can be those of FIGS. 1-9. Repetitive description of like elements and/or processes employed in previously described embodiments is omitted for sake of brevity.

At operation 1202, the process flow 1200 can comprise assigning, by a system (e.g., weighting component 112) comprising at least one processor (e.g., processor 106), weights (e.g., weights 140) to landslide uncertainties (e.g., landslide uncertainties 142) corresponding to landslide parameters (e.g., landslide parameters 132) based on region parameters (e.g., region parameters 134) for a land region (e.g., land region 400).

At operation 1204, the process flow 1200 can comprise generating, by the system (e.g., weighting component 112), the weights based on the region parameters defining a topography of the land region.

At operation 1206, the process flow 1200 can comprise determining, by the system (e.g., identifying component 110), rainfall data (e.g., rainfall data 230) that is live rainfall data or is predicted about 24 hours or less in advance from a current time.

At operation 1208, the process flow 1200 can comprise, based on rainfall data for the land region, quantifying by the system (e.g., uncertainty component 114) propagation of landslide uncertainties over a specified range of time that is about 24 hours or less in advance from a current time.

At operation 1210, the process flow 1200 can comprise quantifying, by the system (e.g., uncertainty component 114), the propagation of the landslide uncertainties comprising at least one of landslide source data indicative of a source of the landslide, landslide volume data indicative of a volume of the landslide, and landslide runout data indicative of a runout distance of the landslide (e.g., landslide data 232).

At operation 1212, the process flow 1200 can comprise determining, by the system (e.g., identifying component 110), region parameters comprising a topography parameter representative of a topography for the land region, an economic distribution parameter representative of an economic distribution for the land region, and a population distribution parameter representative of a population distribution for the land region.

At operation 1214, the process flow 1200 can comprise, based on region parameters and a probability of landslide occurrence (e.g., probability of landslide occurrence 160), generating, by the system (e.g., evaluating component 116) damage data (e.g., damage data 190) defining predicted economic damage (e.g. affected buildings 192) and predicted loss of life (e.g., fatalities 194) over a specified range of time that is about 24 hours or less in the future from a current time.

At operation 1216, the process flow 1200 can comprise generating, by the system (e.g., generating component 118), report data (e.g., report data 198) defining the landslide uncertainties over the specified range of time.

At operation 1218, the process flow 1200 can comprise generating, by the system (e.g., generating component 118), the report data comprising the damage data.

At operation 1220, the process flow 1200 can comprise iteratively identifying, by the system (e.g., identifying component 110 with and/or without direction of the iterating component 122), the rainfall data at a specified frequency.

At operation 1222, the process flow 1200 can comprise determining whether the rainfall is predicted to continue. If yes, the process flow 1200 can proceed to operation 1224. If not, the process flow 1200 can end.

At operation 1224, the process flow 1200 can comprise iteratively generating, by the system (e.g., generating component 118 with and/or without direction of the iterating component 122), the report data at the specified frequency.

For simplicity of explanation, the computer-implemented methodologies and/or processes provided herein are depicted and/or described as a series of acts. The subject application is not limited by the acts illustrated and/or by the order of acts, for example acts can occur in one or more orders and/or concurrently, and with other acts not presented and described herein. The operations of process flows of the figures provided herein are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, described is technology that facilitates assessment of landslide-related uncertainties 142 to forecast one or more consequences (e.g., characterized by one or more probabilities 180-186) and/or damages (e.g., characterized by damage data 180) corresponding to a predicted landslide 402. For instance, operations can be performed, comprising identifying a set of region parameters 134 defining a land region 400 that is susceptible to landslides, identifying rainfall data 230 representative of rainfall for the land region 400, based on the rainfall data 230 and the set of region parameters 134, assessing probability of landslide occurrence 160, and generating report data 198 representative of the predicted landslide 402 comprising probability data 330 indicative of the probability of landslide occurrence 160.

Indeed, in view of the one or more embodiments described herein, a practical application of the above-indicated method, system and/or non-transitory computer-readable medium can be an ability to provide a proactive process for landslide damage prediction as opposed to existing reactive processes. In this way, societal resilience can be enhanced in the face of climate change adaptation. This can be accomplished at least through generation and provision of a concise report including landslide probabilities and predicted damage and loss of life assessments for a particular region of land. That is, the practical application can comprise an ability to provide a concise one-page risk assessment report for which the underlying data can be generated using a common computing device, such as a laptop. In this way, the one or more embodiments described herein are user friendly and have a low barrier to use, and thus the use can be more widespread.

These are useful and practical applications of computers, thus providing enhanced (e.g., improved and/or optimized) landslide probability and associated damage probability generations, based not only on rainfall data, but also on one or more region parameters defining a region in which the landslide can occur and/or one or more landslide parameters describing physics of a possible landslide. Overall, such tools can constitute a concrete and tangible technical and/or physical improvement in the fields of pod or cluster instantiation, comprising volume provisioning.

Furthermore, one or more embodiments described herein can be employed in a real-world system based on the disclosed teachings. For example, one or more embodiments described herein can function with a computer system to execute accurate prediction of both economic damage (e.g., infrastructure damage) and loss of life (e.g., fatalities) based on accurate prediction of landslides using a framework for quantifying the propagation of uncertainties in landslide source, volume, runout and/or impact, without being limited thereto, at a regional scale. Likewise, the one or more embodiments described herein can facilitate notification regarding various risks, resource allocation, and/or targeted emergency response, all based on the one or more predictions provided.

Further, one or more embodiments described herein are inherently and/or inextricably tied to computer technology and cannot be implemented outside of a computing environment. For example, one or more processes performed by one or more embodiments described herein can more efficiently, and/or more feasibly, provide computer-aided and automatic provision of landslide probabilities, damage probabilities, etc., for use in and/or for supporting proactive processes including, but not limited to risk communication, resource allocation and/or emergency response, and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively access computer-stored data, generate computer data, generate and/or employ a data probability construct, and/or communicate with a computer-based interface at a digital level of computerized communication, as the one or more embodiments described herein can facilitate these processes. And, neither can the human mind nor a human with pen and paper automatically perform one or more of the processes as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud operation systems, computer architecture and/or another technology.

One or more embodiments described herein can be fully operational towards performing one or more other functions (e.g., fully powered on, fully executed and/or another function) while also performing the one or more operations described herein.

The paragraphs that follow provide additional summary reciting an example system, an example method and an example non-transitory machine-readable medium.

An example system can comprise at least one processor, and at least one memory that stores executable instructions that, when executed by the at least one processor, facilitate performance of operations, comprising identifying a set of region parameters defining a land region that is susceptible to landslides, identifying rainfall data representative of rainfall for the land region, based on the rainfall data and the set of region parameters, assessing probability of landslide occurrence, and generating report data representative of the predicted landslide comprising probability data indicative of the probability of landslide occurrence.

In the example system, the rainfall data can comprise live rainfall data representative of live rainfall for the land region or predicted rainfall data of predicted rainfall for the land region within about 1 day from a current time.

In the example system, the operations can further comprise quantifying propagation of uncertainties in landslide parameters over a specified range of time that is within about 1 day from a current time, resulting in quantified uncertainty values. Additionally, the report data can further comprise uncertainty data indicative of the quantified uncertainty values.

In the example system, the operations can further comprise assigning weights to the uncertainties based on the set of region parameters, and the quantifying of the propagation of the uncertainties can comprise quantifying the propagation of the uncertainties based on the weights.

In the example system, the operations can further comprise, based on the set of region parameters and the probability of landslide occurrence, generating damage data defining economic damage over a specified range of time that is within about 1 day from a current time, and wherein the report data further comprises the damage data.

In the example system, the operations can further comprise, based on the set of region parameters and the probability of landslide occurrence, generating damage data defining loss of life over a specified range of time that is within about 1 day from a current time. Additionally, the report data can further comprise the damage data.

In the example system, the operations can further comprise iteratively identifying the rainfall data at a specified frequency and iteratively generating the report data at the specified frequency.

In the example system, the generating of the report data can comprise transmitting the report data to a consumer device.

An example method can comprise assigning, by a system comprising at least one processor, weights to landslide uncertainties corresponding to landslide parameters based on region parameters for a land region, based on rainfall data for the land region, quantifying propagation of the landslide uncertainties over a specified range of time that is about 24 hours or less in advance from a current time, and generating report data defining the landslide uncertainties over the specified range of time.

In the example method, the rainfall data can be live rainfall data or can be predicted about 24 hours or less in advance from a current time.

In the example method, the report data can define the landslide uncertainties comprises at least one of landslide source data indicative of a source of the landslide, landslide volume data indicative of a volume of the landslide, or landslide runout data indicative of a runout distance of the landslide.

The example method can further comprise generating the weights based on the region parameters defining a topography of the land region.

The example method can further comprise, based on the region parameters and a probability of landslide occurrence, generating damage data defining predicted economic damage and predicted loss of life over a specified range of time that is about 24 hours or less in the future from a current time, and the report data can comprise the damage data.

The example method can further comprise iteratively identifying the rainfall data at a specified frequency, and iteratively generating the report data at the specified frequency.

In the example method, the region parameters can comprise a topography parameter representative of a topography for the land region, an economic distribution parameter representative of an economic distribution for the land region, and a population distribution parameter representative of a population distribution for the land region.

A non-transitory machine-readable medium can comprise executable instructions that, when executed by at least one processor facilitate performance of operations, comprising, based on rainfall data that is live rainfall data applicable to a land region or predicted rainfall applicable to the land region predicted within a first specified range of time, generating a landslide probability distribution corresponding to the land region and a landslide volume distribution corresponding to the land region, based on a group of region parameters for the land region, comprising a topography parameter corresponding to a topography for the land region, an economic distribution parameter corresponding to the land region, and a population distribution parameter corresponding to a population distribution corresponding to the land region, generating damage data corresponding to the land region based on the landslide probability distribution and the landslide volume distribution, and generating report data comprising the damage data over a group of time points of a second specified range of time.

With respect to the example non-transitory machine-readable medium, the generating of the damage data can comprise generating the damage data by employing a Monte Carlo simulation that results in at least one of a first quantity of affected properties or a second quantity of losses of life.

With respect to the example non-transitory machine-readable medium, the operations can further comprise assigning respective probabilities for the first quantity of affected properties or the second quantity of losses of life at different time points of the group of time points.

With respect to the example non-transitory machine-readable medium, the operations can further comprise sending the report data to at least one administrative service corresponding to the land region comprising sending the report data to at least one device associated with the at least one administrative service with at least one recommended action to initiate determined based on the report data.

With respect to the example non-transitory machine-readable medium, at least one of the first specified range of time or the second specified range of time can range from a current time to about 24 hours from the current time, and the operations can further comprise iteratively identifying the rainfall data at a specified frequency, and iteratively generating the report data at the specified frequency.

### Example Operating Environment

FIG. 14 is a schematic block diagram of an operating environment 1400 with which the described subject matter can interact. The operating environment 1400 comprises one or more remote component(s) 1410. The remote component(s) 1410 can be hardware and/or software (e.g., threads, processes, computing devices). In one or more embodiments, remote component(s) 1410 can be a distributed computer system, connected to a local automatic scaling component and/or programs that use the resources of a distributed computer system, via communication framework 1440. Communication framework 1440 can comprise wired network devices, wireless network devices, mobile devices, wearable devices, radio access network devices, gateway devices, femtocell devices, servers, etc.

The operating environment 1400 also comprises one or more local component(s) 1420. The local component(s) 1420 can be hardware and/or software (e.g., threads, processes, computing devices). In one or more embodiments, local component(s) 1420 can comprise an automatic scaling component and/or programs that communicate/use the remote resources 1410 and 1420, etc., connected to a remotely located distributed computing system via communication framework 1440.

One possible communication between a remote component(s) 1410 and a local component(s) 1420 can be in the form of a data packet adapted to be transmitted between two or more computer processes. Another possible communication between a remote component(s) 1410 and a local component(s) 1420 can be in the form of circuit-switched data adapted to be transmitted between two or more computer processes in radio time slots. The operating environment 1400 comprises a communication framework 1440 that can be employed to facilitate communications between the remote component(s) 1410 and the local component(s) 1420, and can comprise an air interface, e.g., interface of a UMTS network, via an LTE network, etc. Remote component(s) 1410 can be operably connected to one or more remote data store(s) 1450, such as a hard drive, solid state drive, subscriber identity module (SIM) card, electronic SIM (eSIM), device memory, etc., that can be employed to store information on the remote component(s) 1410 side of communication framework 1440. Similarly, local component(s) 1420 can be operably connected to one or more local data store(s) 1430, that can be employed to store information on the local component(s) 1420 side of communication framework 1440.

### Example Computing Environment

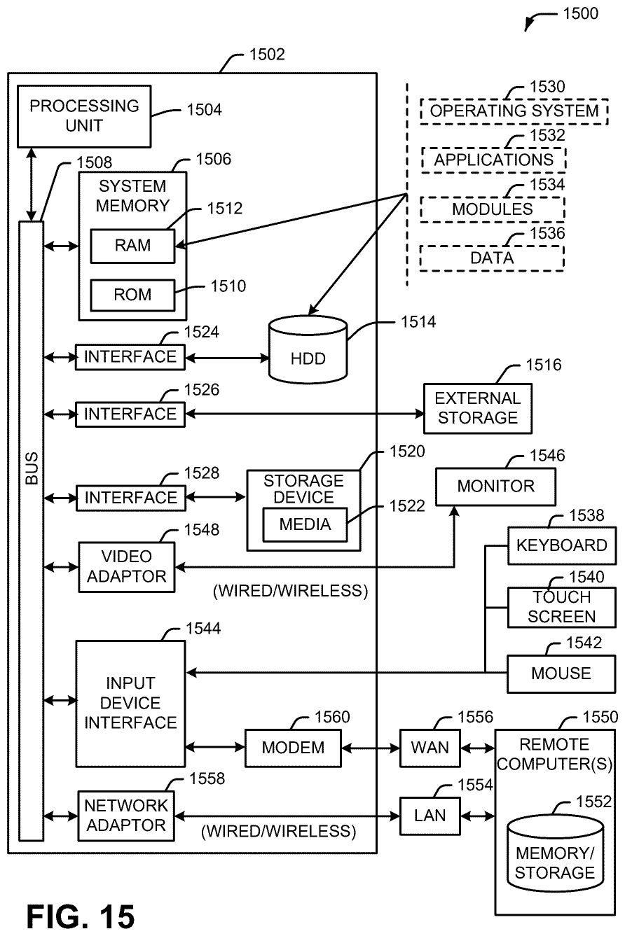

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 15, the example computing environment 1500 which can implement one or more embodiments described herein includes a computer 1502, the computer 1502 including a processing unit 1504, a system memory 1506 and a system bus 1508. The system bus 1008 couples system components including, but not limited to, the system memory 1006 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), and can include one or more external storage devices 1516 (e.g., a magnetic floppy disk drive (FDD) 1516, a memory stick or flash drive reader, a memory card reader, etc.). While the internal HDD 1514 is illustrated as located within the computer 1502, the internal HDD 1514 can also be configured for external use in a suitable chassis (not shown). Additionally, while not shown in computing environment 1500, a solid-state drive (SSD) could be used in addition to, or in place of, an HDD 1514.

Other internal or external storage can include at least one other storage device 1520 with storage media 1522 (e.g., a solid-state storage device, a nonvolatile memory device, and/or an optical disk drive that can read or write from removable media such as a CD-ROM disc, a DVD, a BD, etc.). The external storage 1516 can be facilitated by a network virtual machine. The HDD 1514, external storage device 1516 and storage device (e.g., drive) 1520 can be connected to the system bus 1508 by an HDD interface 1524, an external storage interface 1526 and a drive interface 1528, respectively.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can also be connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer 1550. The remote computer 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. The network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of these instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation for performing the same or equivalent function of the corresponding implementation without deviating therefrom. Still further, multiple processing chips or multiple devices can share the performance of one or more functions described herein, and similarly, storage can be implemented across different devices. Accordingly, the various embodiments are not to be limited to any single implementation, but rather are to be construed in breadth, spirit, and scope in accordance with the appended claims.

What is claimed is:

1. A system, comprising:
at least one processor; and
at least one memory that stores executable instructions that, when executed by the at least one processor, facilitate performance of operations, comprising:
identifying a set of region parameters defining a land region that is susceptible to landslides;
identifying rainfall data representative of rainfall for the land region;
based on the rainfall data and the set of region parameters, assessing probability of landslide occurrence; and
generating report data representative of the predicted landslide comprising probability data indicative of the probability of landslide occurrence.

2. The system of claim 1, wherein the rainfall data comprises live rainfall data representative of live rainfall for the land region or predicted rainfall data of predicted rainfall for the land region within about 1 day from a current time.

3. The system of claim 1, wherein the operations further comprise:
quantifying propagation of uncertainties in landslide parameters over a specified range of time that is within about 1 day from a current time, resulting in quantified uncertainty values, and wherein the report data further comprises uncertainty data indicative of the quantified uncertainty values.

4. The system of claim 3, wherein the operations further comprise:
assigning weights to the uncertainties based on the set of region parameters, and wherein the quantifying of the propagation of the uncertainties comprises quantifying the propagation of the uncertainties based on the weights.

5. The system of claim 1, wherein the operations further comprise:
based on the set of region parameters and the probability of landslide occurrence, generating damage data defining economic damage over a specified range of time that is within about 1 day from a current time, and wherein the report data further comprises the damage data.

6. The system of claim 1, wherein the operations further comprise:
based on the set of region parameters and the probability of landslide occurrence, generating damage data defining loss of life over a specified range of time that is within about 1 day from a current time, and wherein the report data further comprises the damage data.

7. The system of claim 1, wherein the operations further comprise:
iteratively identifying the rainfall data at a specified frequency; and
iteratively generating the report data at the specified frequency.

8. The system of claim 1, wherein the generating of the report data comprises:
transmitting the report data to a consumer device.

9. A method, comprising:
assigning, by a system comprising at least one processor, weights to landslide uncertainties corresponding to landslide parameters based on region parameters for a land region;
based on rainfall data for the land region, quantifying propagation of the landslide uncertainties over a specified range of time that is about 24 hours or less in advance from a current time; and
generating report data defining the landslide uncertainties over the specified range of time.

10. The method of claim 9, wherein the rainfall data is live rainfall data or is predicted about 24 hours or less in advance from a current time.

11. The method of claim 9, wherein the report data defining the landslide uncertainties comprises at least one of landslide source data indicative of a source of the landslide, landslide volume data indicative of a volume of the landslide, and landslide runout data indicative of a runout distance of the landslide.

12. The method of claim 9, further comprising:
generating the weights based on the region parameters defining a topography of the land region.

13. The method of claim 9, further comprising:
based on the region parameters and a probability of landslide occurrence, generating damage data defining predicted economic damage and predicted loss of life over a specified range of time that is about 24 hours or less in the future from a current time, and wherein the report data comprises the damage data.

14. The method of claim 9, further comprising:
iteratively identifying the rainfall data at a specified frequency; and
iteratively generating the report data at the specified frequency.

15. The method of claim 9, wherein the region parameters comprise a topography parameter representative of a topography for the land region, an economic distribution parameter representative of an economic distribution for the land region, and a population distribution parameter representative of a population distribution for the land region.

16. A non-transitory machine-readable medium, comprising executable instructions that, when executed by at least one processor facilitate performance of operations, comprising:
based on rainfall data that is live rainfall data applicable to a land region or predicted rainfall applicable to the land region predicted within a first specified range of time, generating a landslide probability distribution corresponding to the land region and a landslide volume distribution corresponding to the land region;
based on a group of region parameters for the land region, comprising a topography parameter corresponding to a topography for the land region, an economic distribution parameter corresponding to the land region, and a population distribution parameter corresponding to a population distribution corresponding to the land region, generating damage data corresponding to the land region based on the landslide probability distribution and the landslide volume distribution; and
generating report data comprising the damage data over a group of time points of a second specified range of time.

17. The non-transitory machine-readable medium of claim 16, wherein the generating of the damage data comprises:
generating the damage data by employing a Monte Carlo simulation that results in at least one of a first quantity of affected properties or a second quantity of losses of life.

18. The non-transitory machine-readable medium of claim 17, wherein the operations further comprise:
assigning respective probabilities for the first quantity of affected properties or the second quantity of losses of life at different time points of the group of time points.

19. The non-transitory machine-readable medium of claim 16, wherein the operations further comprise:
sending the report data to at least one administrative service corresponding to the land region comprising sending the report data to at least one device associated with the at least one administrative service with at least one recommended action to initiate determined based on the report data.

20. The non-transitory machine-readable medium of claim 16, wherein at least one of the first specified range of time or the second specified range of time ranges from a current time to about 24 hours from the current time, and wherein the operations further comprise:
iteratively identifying the rainfall data at a specified frequency; and
iteratively generating the report data at the specified frequency.
